(19) United States
(12) Patent Application Publication
(10) Pub. No.: US 2002/0192416 A1
(43) Pub. Date: Dec. 19, 2002

(54) Synthetic paper shelf liner

(76) Inventors: James K. Hawley, Sheffield Village, OH (US); Elizabeth A. Flores, Sheffield Lake, OH (US)

Correspondence Address: Stephen D. Harper, Law Department, Suite 200, 2500 Renaissance Blvd., Gulph Mills, PA, 19406, US

(21) Appl. No.: 09/882,788

(22) Filed: Jun. 15, 2001

(51) Int. Cl. B32B 7/06

(52) U.S. Cl. 428/40.1; 428/354

(57) ABSTRACT

A shelf liner composite structure having as the supporting substrate a synthetic paper having a coating or film of a polymeric material on a first surface and a repositionable adhesive on a second surface. The composite structure optionally has a tie coating between the adhesive and the synthetic paper. The adhesive has a stronger bond with the synthetic paper or tie coating than with the coating or film on the first surface.

### BACKGROUND OF THE INVENTION

Currently, composite shelf liners are produced using paper comprised of natural fibers, particularly fibers derived from plant material such as woodpulp, cotton flax, and the like. Paper formed from plant fibers is porous and readily absorbs water and other liquids. The shelf liners formed from plant fibers are generally decorated and coated with a resin material on a top side and coated with an adhesive on a bottom side.

The present shelf liners have problems with water absorption of the fibers which cause formation of bubble like protrusions in the liner and a separation of the liner from the adhesive. The plant fiber paper shelf liners also have a tendency to tear, leaving portions of the shelf liner attached to the shelves when the shelf liner is removed or repositioned. Plant fiber shelf liners have a tendency to be attacked by various molds which cause discoloration of the fibers and an undesirable appearance of the shelf liner.

If the thickness of the paper is increased to provide additional strength to the shelf liner, the shelf liner becomes less flexible and more difficult to store and position on a shelf.

To reduce the water absorption of the fibers, the top surface of the shelf liner is generally decorated and coated with a water-resistant coating material. The coating material provides a water-resistant coating over the surface of the paper and reduces the water absorption of the shelf liner.

### BRIEF SUMMARY OF THE INVENTION

The invention is a synthetic paper shelf liner composite comprising a sheet of flexible synthetic paper, having on a second side a layer of a repositionable adhesive, and having on a first side a coating of at least one polymeric material (preferably a silicone resin). The first side can be decorated to provide an interesting appearance. The shelf liner can have a layer of a tie coating between the synthetic paper and the layer of repositionable adhesive.

The shelf liner is generally prepared, cut to size and sold in a form of a roll.

### BRIEF DESCRIPTION OF THE DRAWINGS

FIG. 1 is a cross-sectional view of an embodiment of the shelf liner of the invention.

FIG. 2 is a cross-sectional view of a second embodiment of the shelf liner of the shelf liner of the invention.

FIG. 3 is a cross-sectional view of a third embodiment of the shelf liner of the invention.

FIG. 4 is a cross-sectional view of a fourth embodiment of the shelf liner of the invention.

FIG. 5 is a plan view of a portion of a shelf liner of the invention.

### DETAILED DESCRIPTION OF THE INVENTION

As used herein, the term synthetic paper refers to a flexible, thin sheet of a composition comprising a synthetic polymer preferably a polyolefin or copolyolefin. The synthetic paper and the composite preferably contains substantially no wood or vegetable fibers. However, the synthetic paper can contain animal or vegetable fibers to the extent that the animal or vegetable fibers do not substantially increase the water absorption and swelling of the paper when contacted with moisture. The synthetic paper can contain additives such as stabilizers, antioxidants, water insoluble fillers, dyes, flow agents and other materials which are generally included in plastic or resin formulations.

The synthetic paper is preferably formed as a continuous film but can be laid down as a mat of resin fibrils. The synthetic paper is preferably formed from a polyolefin or copolyolefin, polyester, or the like. If the synthetic paper is formed from resin fibrils, the shelf liner will not have the disadvantages such as water absorption and swelling exhibited by conventional shelf liners comprising a layer of plant fibers.

A preferred synthetic paper comprises a polymer film. Films of a polyolefin such as polypropylene, polyethylene, copolyethylene or copolypropylene, terphthalate polyester films, and the like are useful. Preferably the synthetic paper comprises a polyethylene, copolyethylene, polypropylene or copolypropylene film. The synthetic paper can contain known mineral fillers such as clay, baryte, calcium carbonate, titanium dioxide, silica and the like, antioxidants, stabilizers, colorants, plasticizers and other materials which are generally included polymer formulations.

As used herein the term flexible refers to the ability of the synthetic paper to be formed in a roll, repositioned on a surface and removed from the surface without becoming permanently creased, folded or dimpled.

A relatively high tensile strength synthetic paper is preferred in the present invention so that the shelf liner may be thin and flexible yet resistant to tearing and stretching when unwound from a roll or when removed from a surface. Preferably the synthetic paper has a tensile strength of at least 1000 pounds per square inch in the machine and cross-machine direction, more preferably a tensile strength of at least 1,500 pounds per square inch in the machine and cross-machine directions and most preferably a tensile strength of at least 2,000 pounds per square inch in the machine and cross-machine directions.

The synthetic paper as formed preferably comprises a major portion of olefin residues and particularly α olefin residues. The polymer is preferably a copolyolefin containing the residues of at least two olefins. Preferably the polyolefin contains propylene residues and most preferably at least 50% propylene residues.

Synthetic paper useful in the present invention comprises polymers formulated and processed to have the characteristics of paper with respect to ink receptivity, ink adhesion, hand and flexibility. The surface can be printed, colored, or embossed to provide a decorated surface. In addition the shelf liner formed is flexible. The synthetic paper is preferably formed as a film.

To improve adhesion, the synthetic paper may be modified according to the teachings of U.S. Pat. No. 3,944,511 or PCT/EP 96/04179 which disclose modification of polymers, particularly polyolefins or copolyolefins to provide improved adhesion of inks, coatings and adhesives.

Preferably, the synthetic paper comprises a polyolefin or copolyolefin containing additives which provide a surface which is similar to paper in relation to ink absorption, adhesion and hand. The synthetic paper useful in the practice of the present invention preferably has a thickness of from about 85 microns to about 150 microns and preferably from about 90 microns to about 120 microns. The thickness can be greater or smaller dependent on the flexibility of the synthetic paper and also its tensile strength. The thickness of the synthetic paper is also dependent upon additional resin films used to form the composite. The surface of the synthetic paper can be treated chemically, by flame treatment, by corona discharge or the like to improve adhesion to inks, coatings and adhesives. A preferred synthetic paper is supplied by NAN-YA Co. and designated as BCD and is a copolyolefin impregnated with clay and surface treated by a corona discharge and has a tensile strength of about 4000 psi in the machine direction (about 625% elongation) and about 3400 psi in the cross-machine direction (about 225% elongation).

The synthetic paper can be decorated by embossing, printing or other means to provide a decorative appearance to the upper surface (first surface) of the synthetic paper. In an alternative embodiment, a thin polymeric film can be laminated to the upper surface of the synthetic paper and the thin film laminate can carry the decoration. The film can be laminated to the surface of synthetic paper by known means.

An adhesive is applied to the back surface (second surface) of the synthetic paper shelf liner. The adhesive is a repositionable adhesive. As used herein, the term repositionable adhesive refers to an adhesive which forms a strong bond with the synthetic paper but forms only a weak bond with the shelf or polymer coated first surface of the shelf liner composite. These adhesives are preferably of the class known as pressure sensitive adhesives and provide a temporary bond between the shelf and the shelf liner. Adhesives such as hot melt adhesives, radiation curable adhesives and the like are useful. Pressure sensitive adhesives can be modified to provide a suitable amount of adhesion yet provide a shelf liner which can be repositioned and easily moved. Examples of suitable adhesives are shown in U.S. Pat. No. 4,783,354 and U.S. Pat. No. 4,151,319, the contents of which are incorporated herein by reference in their entirety.

To ensure a strong bond between the adhesive and the shelf liner, the synthetic paper can be treated to improve the bond between the adhesive and the synthetic paper and/or a tie coating can be provided between the synthetic paper and the adhesive. The bond between the adhesive and the shelf should be much weaker than the bond between the adhesive and the synthetic paper so that when the shelf liner is removed or repositioned, the adhesive adheres to the synthetic paper and is removed substantially completely from the shelf.

If the selected adhesive does not adhere strongly to the synthetic paper, a tie coating can be provided between the synthetic paper and the adhesive. A tie coating comprises a layer of a material between the synthetic paper and the adhesive which increases the bond strength between the adhesive and the synthetic paper. A polyethyleneimine type resin material sold under the tradename POLYMINE by BASF can be used as a tie coating to provide a strong bond between a synthetic paper and an adhesive.

The synthetic paper can be treated by means such as flame treatment, corona discharge, chemical oxidation and immobilization of amphiphilic chemical compounds at the surface of the synthetic paper to improve the bond between the synthetic paper and the adhesive on the second surface of the shelf liner. These methods can be sufficient at times to provide a bond between the adhesive and the synthetic paper which is sufficiently strong that a tie coating is not required to improve the bond between the synthetic paper and the adhesive. The need for additional treatments to ensure a strong bond between the adhesive and the synthetic paper is dependent, to a large extent, on the nature of the synthetic paper and the adhesive selected.

The adhesive can be applied to the synthetic paper as a continuous layer or by an intaglio or printing method which provides islands of the adhesive over the second surface of the synthetic paper.

The top surface (first surface) of the synthetic paper is generally decorated or the decoration can be incorporated in a polymeric film applied over the upper surface (first surface) of the synthetic paper. The decoration can comprise embossing, printing, coloring and the like. To protect the surface of the synthetic paper and the decoration, the synthetic paper top surface, after application of the decoration, is coated with a coating material or can be laminated with a polymeric film. If the top coating comprises a film laminated to the upper surface of the synthetic paper, the decoration can be provided on the film and the top surface of the synthetic paper need not be decorated. The polymeric material provides a smooth coating and a surface on which the articles placed on the shelf can be readily moved. The top coating or laminate provides additional protection to the decoration, reduces water contact with the synthetic resin paper and in addition is selected so that it acts as an anti stick or release layer so that the shelf paper can be formed as a roll without the need for a release sheet backing to prevent sticking of the adhesive to the upper surface of the shelf liner. The shelf liner is generally sold in rolls which can be cut to size for a particular shelf.

A web of the synthetic paper is first decorated on the side which will become the top side or first surface of the synthetic paper. In an alternative method, a decorated film of a polymer material can be laminated to the top side of the synthetic paper. The decorations can comprise embossing, printing, spraying, dye transfer, dyeing and the like to provide a pleasant appearance to the upper surface of the synthetic paper shelf liner. After the printing and decoration, the upper or first surface of the synthetic paper is coated with a resin coating material or a laminated film and simultaneously or sequentially the bottom or second surface of the synthetic paper can be coated with a tie layer if required, or with an adhesive. The coated top and bottom surfaces can be dried or cured if required. If a tie coating is required, the adhesive is applied to the tie-coated surface of the synthetic paper after the tie coating has been cured or dried. The adhesive can be applied as a uniform layer or can be applied by a printing means which provides islands of the adhesive over the surface of the synthetic paper which is adjacent to the shelf to be lined.

The top coating or laminate preferably comprises a polymeric material which has a lower adhesion to the adhesive than the synthetic paper or a tie coating if utilized. A preferred top coating material comprises a cross-linked silicone resin. The top coating is preferably applied directly to the decorated synthetic paper to provide release properties. The top surface can be applied at the rate of about 0.5 to about 1.5 lbs./ream and preferably at a rate of from about 0.6 to about 0.9 lbs./ream.

The tie coat or tie layer comprises a material which provides strong bonding between the synthetic paper and the adhesive. The tie coating is thin since all that is required is that the surface of the synthetic paper be coated with the composition and dried or cured as required. A suitable tie coat material comprises a polyethyleneimine and is preferably applied at a rate of from about 0.01 lbs./ream to about 0.25 lbs./ream (calculated on a dry basis) and most preferably at a rate of about 0.02 lbs./ream to about 0.1 lbs./ream. However, other tie coating materials are known in the art and can be useful in the present invention.

The adhesive suitable for use in the present invention comprises a material which forms a weak bond to the shelf or surface over which the liner is placed and a strong bond with the tie coat or the synthetic paper substrate. The adhesive is preferably a pressure sensitive material which forms a stronger adhesive bond to the synthetic paper or tie coat than to the shelf so that when the synthetic shelf liner is moved or repositioned the adhesive is retained on the shelf liner. Since a shelf is horizontal the bond between the shelf and the adhesive need be only strong enough to prevent slipping between the shelf liner and the shelf. In addition, the adhesive has a weak adhesive bond to the top coating of the synthetic paper. The adhesive preferably requires no activation other than finger pressure and should be removable from the shelf or other horizontal surface without leaving a residue. Preferably, the adhesive has a shear load of 0.005 to 0.02 Mpa and a peel load of 300 to 600 N/m. The adhesive is generally applied at the rate of from about 1.5 lbs./ream to about 14 lbs./ream and preferably from about 5 lbs./ream to about 13.5 lbs./ream. The term ream as used herein refers to 3000 square feet of synthetic paper. Pressure sensitive adhesives can be formed from polymers such as polyacrylates (acrylics), rubbers (elastomers), poly(vinyl ethers), polyurethanes, and vinyl acetate polymers and are well known in the art. Tackifiers, plasticizers, fillers, stabilizers, solvents and other such components may be present in addition to one or more polymers. A preferred pressure sensitive adhesive is NACOR 72-9637, a water based pressure adhesive sold by National Starch and Chemical Company.

FIG. 1 is a cross-section of an embodiment of the invention. 7 refers to the entire shelf liner composite structure. 1 refers to the synthetic paper, 2 is an adhesive layer, and 3 is a top coat which can be a silicone resin or another material which forms only a weak bond with the adhesive. An embossing decoration 4 which can be colored is shown on the surface of the synthetic paper.

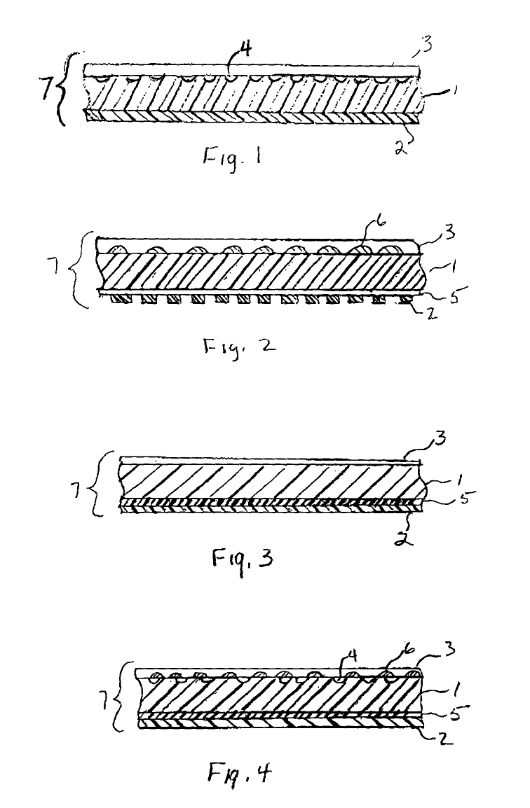

FIG. 2 is a cross-section of a shelf liner of the present invention wherein 7 refers to the composite structure which comprises: a synthetic paper layer 1, a top coat 3 which is placed over a decoration which in this case is printing 6. A tie coat 5 is applied to the surface of the synthetic paper opposite the top coated portioned and a layer of adhesive 2 applied by a printing method. The top coat 3 can be any resin or polymer material which is sufficiently flexible to be formed into a roll without cracking and which does not adhere strongly to the adhesive layer 2 applied to the bottom surface of the shelf liner when the liner is in the form of a roll.

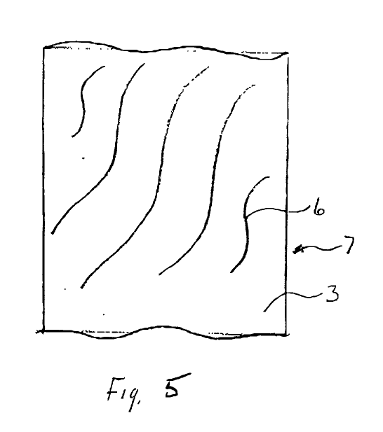

FIG. 3 is a cross-section of an embodiment of the invention in which 7 refers to the composite structure wherein the synthetic paper 1 is coated on a surface with a laminate of a clear film material 3. The decoration to the structure can be provided by a colorant on the synthetic paper 1 or the laminate film 3 can be colored, printed, embossed or otherwise decorated. A tie coating 5 is applied to the bottom surface or second surface of the synthetic paper and an adhesive layer 2 is applied as a uniform layer over the tie coating layer 5.

FIG. 4 is a cross-section of an embodiment of the invention in which 7 represents the composite structure which comprises the synthetic paper 1 having as a decoration an embossed surface 4 over which printing 6 is applied. A top coating or laminate 3 is applied over the embossed and printed surface. On the opposite surface of the synthetic paper, a tie coating 5 is applied as a continuous coating and a continuous coating of an adhesive 2 is applied over the tie coating 5.

FIG. 6 is a plan view of an embodiment of the invention wherein the composite sheet 7 has a decoration 6 applied to the surface and a top coating 3 applied over the surface of the composite 7.

The synthetic paper shelf liner of the invention is generally provided in the form of a roll. The roll of the shelf liner does not require a release sheet since the materials of the composite structure are selected such that the pressure sensitive adhesive does not form a strong bond with the polymeric material forming the first or top surface of the composite structures. The shelf liner can be easily unwound from the roll and positioned on the surface to be covered. The pressure sensitive adhesive forms only a weak bond with the surface and the shelf liner can be easily repositioned and removed when required.

The present invention also encompasses a method for protecting a surface by applying to the surface the composite structure of the invention.

What is claimed is:

1. A composite synthetic paper shelf liner comprising: a sheet of synthetic paper, having on a first side a layer of a polymeric material, and having on a second side a layer of a repositionable adhesive.

2. The composite synthetic paper shelf liner of claim 1 further comprising a layer of a tie coating between the synthetic paper and the layer of repositionable adhesive.

3. The composite synthetic paper shelf liner of claim 1 wherein the layer of polymeric material comprises a silicone polymeric material.

4. The composite synthetic paper shelf liner of claim 1 wherein the synthetic paper has a tensile strength of at least 1000 pounds per square inch in the machine and cross-machine directions.

5. The composite synthetic paper shelf liner of claim 4 wherein the tensile strength is at least 1500 pounds per square inch in the machine and cross-machine direction.

6. The composite synthetic paper shelf liner of claim 4 wherein the synthetic paper comprises a film.

7. The composite synthetic paper shelf liner of claim 1 wherein the synthetic paper has a thickness of from 80 to 150 microns.

8. The composite synthetic paper shelf liner of claim 1 wherein the synthetic paper comprises a polyolefin or a copolyolefin.

9. The composite synthetic paper shelf liner of claim 8 wherein the synthetic paper comprises a copolyolefin.

10. The composite synthetic paper shelf liner of claim 9 wherein the synthetic paper comprises copolypropylene.

11. The composite synthetic paper shelf liner of claim 2 wherein the tie coating comprises a polyethyleneimine.

12. The composite synthetic paper shelf liner of claim 1 wherein the repositionable adhesive comprises a pressure sensitive acrylic adhesive.

13. The composite synthetic paper shelf liner of claim 2 wherein the repositionable adhesive comprises a pressure senstive acrylic adhesive.

14. A combination of a horizontal surface and the shelf liner of claim 1.

15. A method of covering a horizontal surface which comprises applying the shelf liner of claim 1 to the horizontal surface.

16. The composite synthetic paper shelf liner of claim 1 in the form of a roll.

17. The composite synthetic paper shelf liner of claim 16 wherein the shelf liner does not contain a release sheet to prevent contact between the adhesive and the first surface life shelf liner.
